(19) United States
(12) Patent Application Publication
(10) Pub. No.: US 2025/0277367 A1
(43) Pub. Date: Sep. 4, 2025

(54) SPLIT BLOCKS WITH MULTIAXIS LIVING HINGE SYSTEMS AND METHODS FOR MAKING THE SAME

(71) Applicant: Pontiac Trail Products, LLC, Novi, MI (US)

(72) Inventors: John Patrick Miller, Blaine, MN (US); Michael W. Maurer, Novi, MI (US); Christopher David Meeks, Greensboro, NC (US)

(73) Assignee: Pontiac Trail Products, LLC, Novi, MI (US)

(21) Appl. No.: 19/067,146

(22) Filed: Feb. 28, 2025

Related U.S. Application Data
(60) Provisional application No. 63/560,051, filed on Mar. 1, 2024.

(51) Int. Cl. E04C 1/39

(52) U.S. Cl. CPC E04C 1/392

(57) ABSTRACT

A split block assembly includes a backplate with an outwardly projecting mounting flange that mounts to a wall structure such that the flange is interposed between a siding panel and the wall structure. The backplate includes first and second plate segments rotatable with respect to each other between an open position, whereat the first plate segment is spaced from the second plate segment, and a closed position, whereat the plate segments abut and thereby cooperatively define a hole that receives therethrough a fixture. A living hinge system is integral with and rotatably joins the two plate segments. The living hinge system includes a first living hinge adjoining the first plate segment and bending on a first axis, a second living hinge adjoining the second plate segment and bending on a second axis oblique to the first axis, and a flap extending between and joining the two living hinges.

### CLAIM OF PRIORITY AND CROSS-REFERENCE TO RELATED APPLICATION

This application claims the benefit of and priority to U.S. Provisional Patent Application No. 63/560,051, which was filed on Mar. 1, 2024, and is incorporated herein by reference in its entirety and for all purposes.

### TECHNICAL FIELD

The present disclosure relates generally to mounting blocks for constructing buildings and other structures. More specifically, aspects of this disclosure relate to plastic split blocks used for constructing residential and commercial buildings with siding.

### INTRODUCTION

Often when installing construction siding for residential or commercial applications, there is a need for a product called a split recessed mounting block (or “split block” for short) that accommodates fixtures in the walls of the structure. The split block is a specialized type of mounting block that can be split apart to fit around pipes, vents, water faucets, or electrical outlets, thus allowing for installation of siding without having to remove the pre-existing fixture. Essentially, a split block helps to provide an aesthetically pleasing, flush finish around these penetrations while maintaining a watertight seal for the wall. While many applications may utilize a standard mounting block where drilling a hole into a block face is sufficient, such as for wires or tubing, the split block typically has a prefabricated split in a face of the block to accommodate a penetration.

Plastic split blocks used for vinyl and aluminum siding may have a frame-shaped trim ring that snaps onto a backplate of the split block assembly to conceal the cut edges of the surrounding siding. Other siding applications exist where a trim ring may not be needed, such as products like wood, fiber cement, or engineered wood that require caulk. Conventional split block designs typically take on one of two different form factors: (a) a multipiece backplate solution, or (b) a single-piece backplate solution. Most multipiece backplate designs are bipartite constructions typified by top and bottom backplate segments or left and right backplate segments that snap or fasten together around the penetration.

These designs are not practical because multiple pieces innately necessitate more time and labor to manufacture and are more complicated to install. The single-piece design, in contrast, may have a C-clamp like form factor that is fabricated with a solitary hinge on a sidewall of the block to enable the opening and closing of the backplate. While this design typically benefits from reduced manufacturing costs and installation labor savings, many suffer from water penetration issues.

### SUMMARY

Presented herein are split block assemblies having single-piece backplates that are integrally formed with multiaxis living hinges, methods for making and methods for using such split block assemblies, and multiaxis living hinges for pivotably interconnecting two segments of a component. By way of non-limiting example, a multiaxis living hinge system is integrally formed into a one-piece split block backplate (or “base”) to provide a simplified design that reduces manufacturing and installation time and costs while ensuring that the split block assembly has sufficient water protection. The living hinge system may be a tripartite design that consists essentially of three living hinges interconnected by two “inter-hinge” flaps. The multiaxis living hinge system may attach two halves (e.g., top and bottom halves or left and right halves) of a split block backplate. The split block backplate may be injection molded as a unitary, one-piece structure from a structurally resilient thermoplastic polymer material. It is envisioned that the split block assembly may include a single or multiple living hinge systems, each of which may include two or more interconnected living hinges. In addition, use of the terms “half” or “halves” to describe two related segments of a component does not necessarily require that those segments be equal in size; one “half” may be larger than the other “half”.

The living hinge system enables the split block backplate to transition between an open position, in which one half of the backplate pivots away from the other half, and a closed position, in which the two backplate halves seat against each other. In the open position, the two mating “inter-hinge” flaps, which are interleaved between the three living hinges, may lay in different planes from each other and from the two halves of the backplate. Depending on the multiaxis living hinge design, the two halves of the backplate may be mutually coplanar or may lay in distinct planes when in the open position. The two halves of the backplate rotate around a central point of the living hinge system to arrive to the closed position. In the closed position, the inter-hinge flaps of the multiaxis living hinge may be coplanar with each other and, if desired, with the two backplate halves. For some applications, the split block assembly may incorporate a frame-like trim ring that secures onto the split block backplate such that a cut edge of a siding panel is sandwiched between the trim ring and the backplate when the split block is mounted, e.g., via threaded fasteners, onto a wall substrate on the exterior of a building.

Aspects of this disclosure are directed to split block assemblies having single-piece backplates that are integrally formed with multiaxis living hinges. In an example, a split block assembly is presented for a wall structure (e.g., exterior wall substrate of a building) with a fixture (e.g., hose spigot) and a siding panel (e.g., vinyl siding panel). The split block assembly includes a backplate with an outwardly projecting mounting flange that mounts to the wall structure such that the mounting flange is interposed between the siding panel and the wall structure. The backplate includes a first plate segment that is rotatable with respect to a second plate segment between open and closed positions. When in the open position, the first plate segment is spaced from the second plate segment, e.g., to allow the split block assembly to fit around the fixture. Conversely, when in the closed position, the first and second plate segments abut and thereby cooperatively define a fixture hole that receives therethrough the fixture. A living hinge system is integral with and rotatably joins the two plate segments. The living hinge system includes a first living hinge that adjoins the first plate segment and bends on a first axis, a second living hinge that adjoins the second plate segment and bends on a second axis oblique to the first axis, and a flap that extends between and joins the two living hinges.

Further aspects of this disclosure are directed to methods for manufacturing and methods for installing any of the herein described split block assemblies and/or multiaxis living hinge systems. In an example, a method is presented for manufacturing a split block assembly for a wall structure with a fixture and a siding panel. This representative method includes, in any order and in any combination with any of the above and below disclosed options and features: forming a backplate including an outwardly projecting mounting flange configured to mount to the wall structure such that the mounting flange is interposed between the siding panel and the wall structure, the backplate including a first plate segment rotatable with respect to a second plate segment between an open position, whereat the first plate segment is spaced from the second plate segment, and a closed position, whereat the first and second plate segments abut and thereby cooperatively define a fixture hole configured to receive therethrough the fixture; and forming a living hinge system integral with and rotatably joining the first and second plate segments, the living hinge system including a first living hinge adjoining the first plate segment and bending on a first axis, a second living hinge adjoining the second plate segment and bending on a second axis oblique to the first axis, and a flap extending between and joining the first and second living hinges.

For any of the herein described systems, methods, and assemblies, the living hinge system may further include a third living hinge that is interposed between the first and second living hinges and bends on a third axis oblique to the first and second axes. The living hinge system may define an axis of rotation about which the two plate segments rotate; each of the living hinges may be substantially linear and may project radially outward from the axis of rotation. The hinges may also be curvilinear or partially curved. The inter-hinge flap may include a first flap, which is interposed between and adjoins the first and third living hinges, and a second flap, which is interposed between and adjoins the second and third living hinges. Both of these flaps may be triangular and, if desired, may be substantially identical to each other. For at least some applications, the living hinge system consists essentially of three living hinges and two inter-hinge flaps.

For any of the herein described systems, methods, and assemblies, the split block assembly may include a rectangular-annulus trim ring that removably mounts onto an axial face of the backplate when the two plate segments are in the closed position. The backplate may include a rectangular-annulus mounting hub with a plurality of teeth apertures; the trim ring may include a plurality of ribbed teeth that snap-fit into the teeth apertures to thereby removably mount the trim ring to the backplate. The first plate segment may include a first (semicircular) hole segment and the second plate segment may include a second (semicircular) hole segment that aligns with and adjoins the first hole segment to collectively define the fixture hole when the two plate segments are in the closed position.

For any of the herein described systems, methods, and assemblies, the split block assembly may include a locking tooth that projects axially from the first (or second) plate segment, and a locking tab that projects from the second (or first) plate segment towards the other plate segment. The locking tab contains a slot that receives therein the locking tooth to thereby lock together the first and second plate segments when in the closed position. The split block's mounting flange may project outward from and extends around the outer peripheries of the two plate segments. It may be desirable that the backplate—including the mounting flange and first and second plate segments—and the living hinge system—including the multiple living hinges and multiple inter-hinge flaps—be integrally formed as a single-piece structure from a polymeric material.

The above summary does not represent every embodiment or every aspect of the present disclosure. Rather, the foregoing summary merely provides a synopsis of some of the novel concepts and features set forth herein. The above features and advantages, and other features and attendant advantages of this disclosure, will be readily apparent from the following Detailed Description of illustrated examples and representative modes for carrying out the disclosure when taken in connection with the accompanying drawings and appended claims. Moreover, this disclosure expressly includes any and all combinations and subcombinations of the elements and features presented above and below.

### BRIEF DESCRIPTION OF THE DRAWINGS

FIG. 1 is a front-view illustration of a representative split block assembly backplate with a multiaxis living hinge system shown with the backplate in an open position in accordance with aspects of the present disclosure.

FIG. 2 is a side-view illustration of the representative split block backplate of FIG. 1.

FIG. 3 is a front topside, isometric-view illustration of the representative split block backplate of FIG. 1.

FIG. 4 is a front bottom-side, isometric-view illustration of the representative split block backplate of FIG. 1.

FIG. 5 is a rear-view illustration of the representative split block backplate of FIG. 1.

FIG. 6 is a back topside, isometric-view illustration of the representative split block backplate of FIG. 1.

FIG. 7 is a back bottom-side, isometric-view illustration of the representative split block backplate of FIG. 1.

FIG. 8 is a repeat front-view illustration of the representative split block backplate of FIG. 1 shown with a cutting plane line C-C.

FIG. 9 a cross-sectional, side-view illustration of the representative split block backplate of FIG. 1 taken along cutting plane line C-C of FIG. 8.

FIG. 10 is a front-view illustration of the representative split block backplate of FIG. 1 shown in a closed position.

FIG. 11 is a first (left) side-view illustration of the representative split block backplate shown closed in FIG. 10.

FIG. 12 is a top-view illustration of the representative split block backplate shown closed in FIG. 10.

FIG. 13 is a front topside, isometric-view illustration of the representative split block backplate shown closed in FIG. 10.

FIG. 14 is a rear-view illustration of the representative split block backplate shown closed in FIG. 10.

FIG. 15 is a second (right) side-view illustration of the representative split block backplate shown closed in FIG. 10.

FIG. 16 is a back topside, isometric-view illustration of the representative split block backplate shown closed in FIG. 10.

FIG. 17 is a back bottom-side, isometric-view illustration of the representative split block backplate shown closed in FIG. 10.

FIG. 18 is a front-view illustration of a representative split block assembly trim ring mounted onto the closed backplate of FIG. 1 in accordance with aspects of the present disclosure.

FIG. 19 is a front topside, isometric-view illustration of the representative split block trim ring mounted onto the closed split block backplate shown in FIG. 18.

FIG. 20 is a front-view illustration of the representative split block trim ring of FIG. 18.

FIG. 21 is a side-view illustration of the representative split block trim ring of FIG. 18.

FIG. 22 is a rear-view illustration of the representative split block trim ring of FIG. 18.

FIG. 23 is a front topside, isometric-view illustration of the representative split block trim ring of FIG. 18.

FIG. 24 is a rear topside, isometric-view illustration of the representative split block trim ring of FIG. 18.

FIG. 25 is a front bottom-side, isometric-view illustration of the representative split block trim ring of FIG. 18.

FIG. 26 is a rear bottom-side, isometric-view illustration of the representative split block trim ring of FIG. 18.

The present disclosure is amenable to various modifications and alternative forms, and some representative embodiments of the disclosure are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, Brief Description of the Drawings, and Detailed Description sections, but not explicitly set forth in the claims, should not be incorporated into the claims, singly or collectively, by implication, inference or otherwise. Moreover, recitation of “first”, “second”, “third”, etc., in the specification or claims is not per se used to establish a serial or numerical limitation; unless specifically stated otherwise, these designations may be used for ease of reference to similar features in the specification and drawings and to demarcate between similar elements in the claims.

For purposes of this disclosure, unless specifically disclaimed: the singular includes the plural and vice versa (e.g., indefinite articles “a” and “an” should generally be construed as meaning “one or more”); the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein to denote “at, near, or nearly at,” or “within 0-5% of,” or “within acceptable manufacturing tolerances,” or any logical combination thereof, for example.

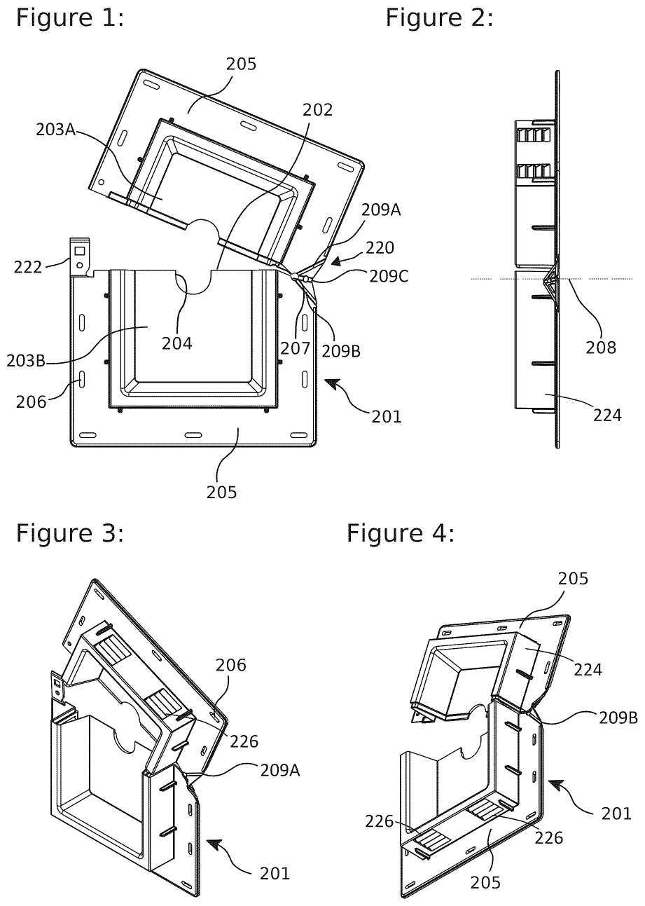

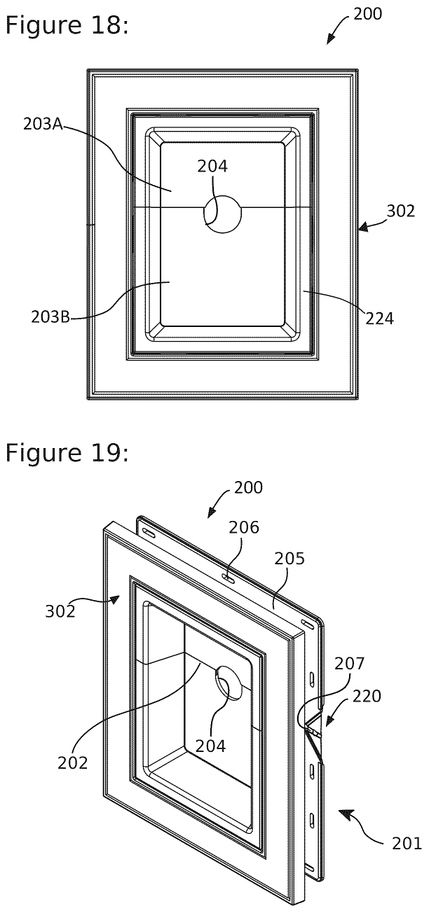

Referring now to the drawings, wherein like reference numbers refer to like features throughout the several views, there is shown in FIG. 1 a split block backplate 201 of a representative split recessed mounting block 200 of FIGS. 18 and 19. The illustrated split recessed mounting block 200—also referred to herein as “split block assembly” or “split block” for short—is merely an exemplary application with which aspects of this disclosure may be practiced. In the same vein, utilization of the present concepts for providing a decorative appearance and water-tight frame to the surrounding area of a water spigot and neighboring vinyl siding of a residential home should also be appreciated as a non-limiting implementation of disclosed features. As such, it will be understood that aspects of this disclosure may be implemented for other fixtures and siding types, may be employed by other split block architectures, and may be utilized for any logically relevant type of building structure.

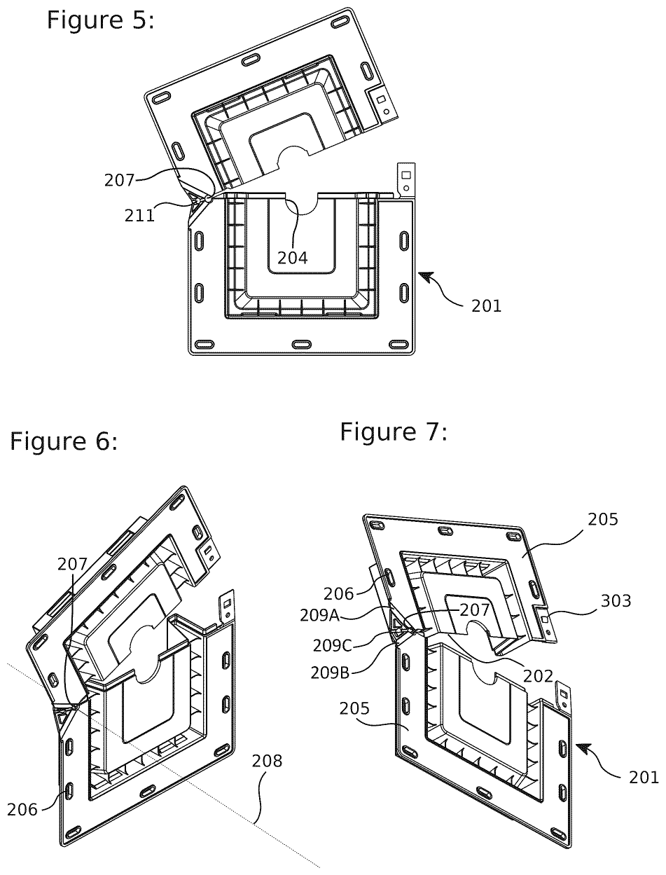

Referring first to FIGS. 1 through 9, the split block backplate 201 is shown in an open position such that the split block assembly 200 can be positioned around an existing fixture of a building structure, such as the pipe neck of a water hose spigot. To that end, the split block assembly 200 may be utilized as a siding accessory to help installers quickly and cleanly finish around penetrations on a house that have enlarged-diameter connections or variable widths, including without limitation pipes, vents, AC lines, electrical outlets, etc. In FIGS. 18 and 19, the split block assembly 200 is shown as a bipartite construction that includes or, if desired, consists essentially of the backplate 201 and a complementary trim ring 302 that releasably mounts onto the backplate 201. For some applications, however, it may be desirable to omit the trim ring 302 such that the split block assembly 200 consists essentially of the backplate 201. It is also envisioned that the respective shapes and sizes of the backplate 201 and trim ring 302 may be varied-individually and collectively-from that which are shown in the drawings to accommodate, for example, different intended applications and design constraints.

Split block backplate 201 of FIG. 1 may be typified by four primary features: (1) a first (top) plate segment 203A, (2) a second (bottom) plate segment 203B, (3) a frame-like mounting flange 205, and (4) a multiaxis living hinge system 220. The split block backplate 201, including the plate segments 203A, 203B, flange 205, and hinge system 220, is portrayed as a single-piece, unitary structure that is integrally formed, in whole or in part, from a rigid and resilient polymeric material, such as polyvinyl chloride (PVC) or polypropylene (PP). The mounting flange 205 projects outward from and extends around the outer peripheries of the two plate segments 203A, 203B effectively surrounding the two segments 203A, 203B. The split block flange 205 mounts, e.g., via screws, fasteners, nails, adhesives, rivets, etc., to a wall structure 301 (FIG. 11) such that the mounting flange 205 is interposed between an exterior cladding, such as a siding panel, siding, stucco, stone, brick, wood, etc., and the wall 301.

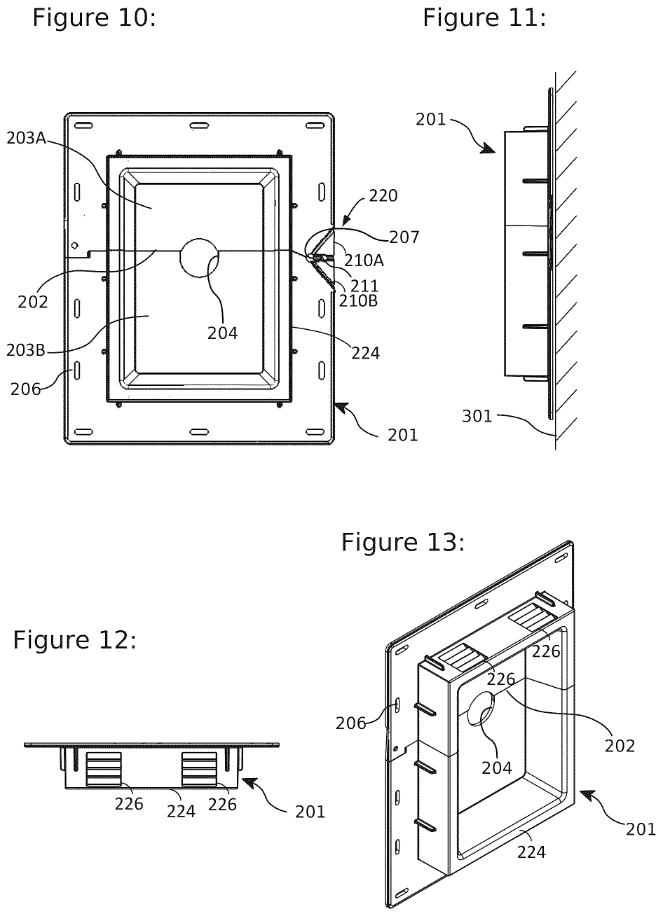

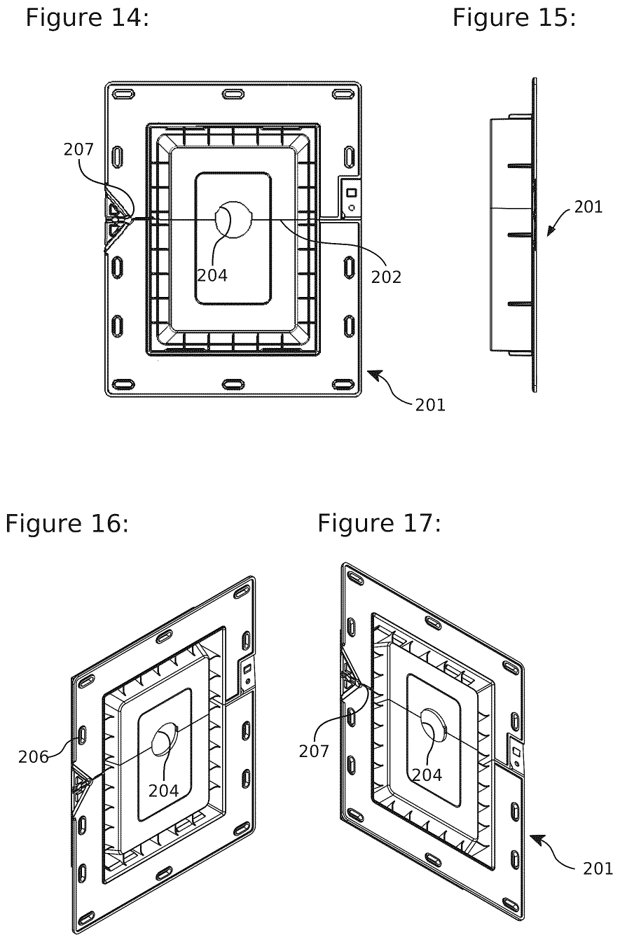

To enable the split block backplate 201 to fit around an existing fixture, the first plate segment 203A is rotatable with respect to the second plate segment 203B such that the backplate 201 can be manually transitioned back-and-forth between an open position (FIGS. 1-8) and a closed position (FIGS. 10-17). When the backplate 201 is in the open position, the first plate segment 203A is rotated (e.g., in a clockwise direction in FIG. 1) and spaced away from the second plate segment 203B. Conversely, when the backplate 201 is in the closed position, the bottom edges of the two plate segments 203A, 203B abut each other and thereby cooperatively define a penetration hole 204 that is shaped and sized to receive therethrough the desired fixture. A block split line 202 separates the two plate segments 203A, 203B and may generally define an interface edge at which the plate segments 203A, 203B abut and extend generally coterminous with each other. For simplicity of design and use, it may be desirable that the backplate 201 only have one (1) block split line 202 that creates two (2) distinct plate segments 203A, 203B. The penetration hole 204 (also referred to herein as “fixture hole”) may have a circular shape (as shown) that is likewise split in half by the block split line 202. The location, size, and/or geometry of the penetration hole 204 may be varied from that which are shown to accommodate other intended applications (e.g., rectangular electrical boxes).

Extending substantially continuously around the outer perimeter of the split block backplate 201 is a substantially flat and rectangular mounting flange 205. This mounting flange 205 may serve two primary purposes: first, a series of fastener holes 206 may be spaced around the perimeter of the mounting flange 205; each of these fastener holes 206 may receive therethrough a respective fastener, such as a screw, that is used to securely mount the split block backplate 201 onto a wall 301. Secondly, the backplate's mounting flange 205 may also act as a “water flashing” barrier that directs water flow away from the wall 301 and prevents the passage of water into the building structure. A weather-resistant tape may be applied around the perimeter of the flange 205 to seal against the ingress and egress of water, dust, air, etc. The mounting flange 205 is not limited to a rectangular design and may take on other regular and irregular geometric shapes and may be continuous or discontinuous.

As noted above, the block split line 202 delineates the backplate 201 into two different plate segments 203A, 203B, which may be distinctly shaped and sized (as shown) or may be structurally mirrored counterparts. FIG. 1, for example, portrays the backplate 201 with the second plate segment 203B being larger than the first plate segment 203A and having a locking tab 222 that projects upward from the lefthand side of the plate segment 203B. FIG. 1 shows that this block split line 202 extends all the way across and completely splits a first (left) side of the mounting flange 205. On a second (right) side of the backplate 201, the block split line 202 terminates into a rotation hole 207 and, thus, does not extend all the way across nor split the right side. The rotation hole 207 is generally located on an axis of rotation 208 (FIG. 2) about which the two block segments 203A, 203B rotate. It should be noted that the axis of rotation 208 should fall inside the rotation hole 207, and will function if concentric or if slightly offset from being perfectly concentric.

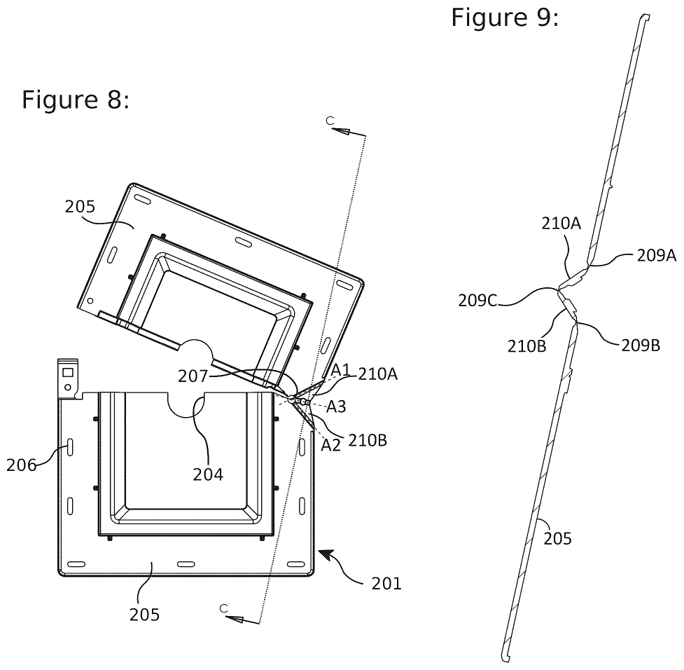

A multiaxis living hinge system 220 is integral with and rotatably joins together the two plate segments 203A, 203B of the split block assembly 200. FIGS. 1 and 9 portray the living hinge system 220 with three distinct living hinges: (1) a first living hinge 209A that adjoins the first plate segment 203A and bends about a first axis A1 (FIG. 8); (2) a second living hinge 209B that adjoins the second plate segment 203B and bends about a second axis A2, which is oblique to the first axis A1; and (3) a third living hinge 209C that is interposed between the first and second living hinges 209A, 209B and bends about a third axis A3, which is oblique to the first and second axes A1, A2. In accord with the illustrated example, all three of the living hinges 209A, 209B, 209C are located on the same side as and, in fact, interest the rotation hole 207 at the end of the block split line 202. The living hinges 209A, 209B, 209C may be, without limitation, all radial to the rotation hole 207. Put another way, each hinge 209A, 209B, 209C is substantially linear and projects radially outward from the axis of rotation 208. Skilled artisans will appreciate that the living hinge system 220 may take on other configurations, including greater or fewer than three living hinges 209A, 209B, 209C each of which may be rectilinear or curvilinear, or both, and may be radial or non-radial with the rotation hole 207. As shown, the first living hinge 209A may be approximately 50-55 degrees from the third living hinge 209C and approximately 100-110 degrees from the second living hinge 209B, and the second living hinge 209B may be approximately 50-55 degrees from the third living hinge 209C.

One or more inter-hinge flaps extend between and operatively interconnect the living hinges 209A, 209B, 209C. For a three-hinge configuration, a first flap 210A (FIG. 8) may be interposed between and adjoin the first and third living hinges 209A, 209C, and a second flap 210B may be interposed between and adjoin the second and third living hinges 209B, 209C. A two-flap living hinge system configuration, in contrast, may employ only a single inter-hinge flap. It may be desirable that the first and second flaps 210A, 210B be triangular (e.g., scalene right triangles) and may be substantially identical to each other. These inter-hinge flaps 210A, 210B are integrally formed with each other and with the living hinges 209A, 209B, 209C to collectively define the multiaxis living hinge system 220. When the split block backplate 201 is in the closed position, the inter-hinge flaps 210A, 210B may be generally coplanar in configuration, e.g., encompassing a broad flat surface. The term “planar”, as used herein, is intended to encompass both perfectly flat surfaces and those surfaces that may exhibit slight deviations from true planarity (e.g., within reasonable manufacturing tolerances). Such deviations may include, but are not limited to, minor undulations, gentle curves, or shallow contours that do not significantly alter the overall planar nature of the component. The planar characteristic of the component may thus be defined in a functional sense, allowing for manufacturing variances, design modifications, or intended non-flat features that are within the scope of a generally flat configuration. It is acceptable for areas of the inter-hinge tabs 210A, 210B to sit as much as ⅜″ higher than the mounting flange 205, for example.

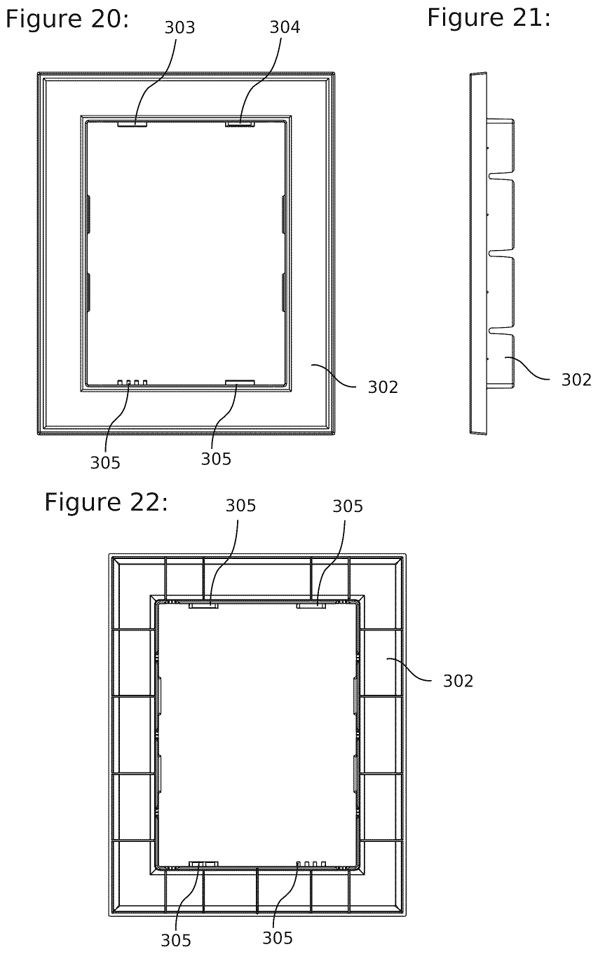

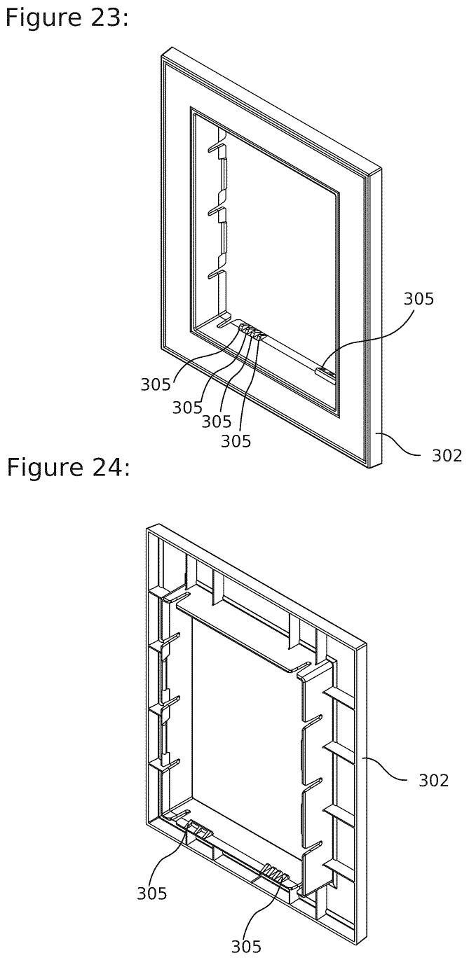

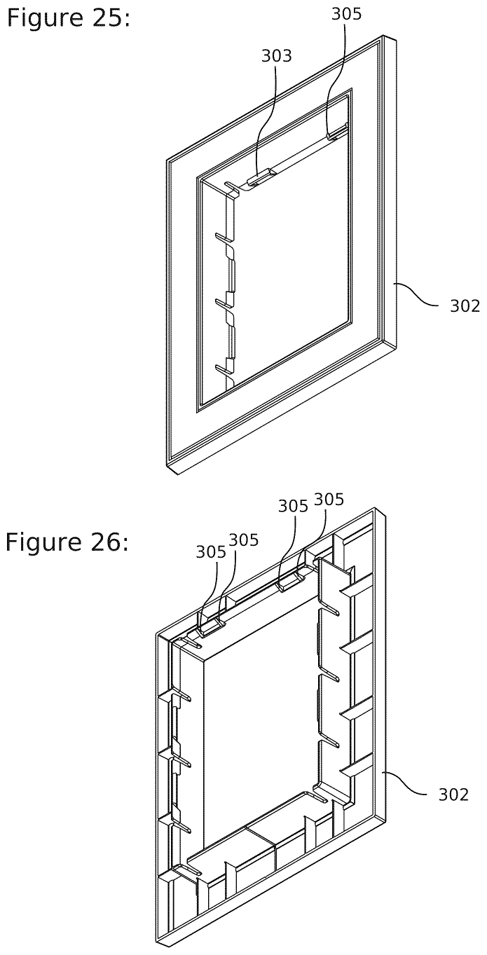

FIG. 18 illustrates a representative split block assembly 200 architecture that includes both the split block backplate 201 and the split block trim ring 302. Trim ring 302 is shown in FIGS. 20-26 having a rectangular-annulus “frame-like” geometric profile; however, the trim ring 302 may take on other regular and irregular geometric shapes. To help simplify installation of the split block assembly 200, the trim ring 302 may removably mount, e.g., via fasteners, snap-lock tabs, clamps, etc., onto an outward-facing axial face of the backplate 201, e.g., when the two plate segments 203A, 203B are in the closed position and the backplate 201 is secured onto the wall structure 301 (FIG. 11). By way of non-limiting example, the split block backplate 201 is fabricated with a central mounting hub 224 that includes multiple sets of teeth apertures 226 (FIGS. 12 and 13), e.g., with two sets of teeth apertures 226 recessed into a top surface of the hub 224 and two sets of teeth apertures 226 recessed into a bottom surface of the hub 224. Split block trim ring 302 is fabricated with complementary ribbed teeth 305 that align with and snap-fit into the teeth apertures 226 and thereby removably mount the trim ring 302 to the backplate 201. It is envisioned that the trim ring 302 is not necessary for all applications and may be installed/attached to the backplate 201 by numerous styles of attachment features.

During installation of the split block assembly 200, the first plate segment 203A may be rotated away from the second plate segment 203B, which causes the first living hinge 209A to bend about the first axis A1 and rotate towards the second living hinge 209B which bends about the second axis A2. In so doing, the inter-hinge flaps 210A, 210B rotate about the third axis A3 towards each other and are concomitantly orientated in a position where they are not coplanar with the mounting flange 205, as best seen in FIGS. 8 and 9. This provides a gap between the two plate segments 203A, 203B that allows feeding of a fixture, e.g., from left to right in FIG. 1, into the fixture hole 204. After positioning the open backplate 201 around the fixture, the two plate segments 203A, 203B are rotated together until they sit flush against each other on block split line 202. When transitioned to the closed position in this manner, the inter-hinge flaps 210A, 210B are once again generally coplanar with each other and with the mounting flange 205.

Rotation hole 207 may be interposed between and, thus, physically separates the block split line 202 and the three living hinges 209A, 209B, 209C. The rotation hole 207 may be located at an inner terminal end of the third living hinge 209C and spaced from a flattening hole 211 (FIG. 10), which may be located at the center of the third living hinge 209C. A fastener can be installed into the flattening hole 211 to ensure that the inter-hinge flaps 210A, 210B are substantially parallel to the wall 301, regardless of tolerances or other factors, generally, when installed. Dimensions may be critical when manufacturing parts with living hinges, including the three living hinges 209A, 209B, 209C. In instances where a trim ring 302 is used, a locking tooth 303 may be employed to secure the trim ring 302 to the backplate 201. Material was removed in areas of the locking tooth 303 to help maintain a consistent part thickness that helps to largely prevent warp; this may define a ribbed locking tooth 304. For at least some applications, the locking tooth 303 may have locking tooth ribs 305 on one or both sides of the locking tooth 303.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. A split block, comprising:
a backplate including a first plate segment rotatable with respect to a second plate segment between an open position, whereat the first plate segment is spaced from the second plate segment, and a closed position, whereat the first and second plate segments abut and intersect at a split block line; and
a living hinge system integral with and rotatably joining the first and second plate segments, the living hinge system including a first living hinge adjoining the first plate segment and bending on a first axis, a second living hinge adjoining the second plate segment and bending on a second axis oblique to the first axis, and a flap extending between and joining the first and second living hinges.

2. The split block of claim 1, wherein the living hinge system further includes a third living hinge interposed between the first and second living hinges and bending on a third axis oblique to the first and second axes.

3. The split block of claim 2, wherein the living hinge system defines an axis of rotation about which the first and second plate segments rotate, and wherein each of the first, second, and third living hinges is substantially linear and projects radially outward from the axis of rotation.

4. The split block of claim 2, wherein the flap includes a first flap interposed between and adjoining the first and third living hinges, and a second flap interposed between and adjoining the second and third living hinges.

5. The split block of claim 4, wherein the first and second flaps are triangular and substantially identical.

6. The split block of claim 4, wherein the living hinge system consists essentially of the first, second and third living hinges and the first and second flaps.

7. The split block of claim 1, further comprising an annular trim ring configured to removably mount onto an axial face of the backplate when the first and second plate segments are in the closed position.

8. The split block of claim 7, wherein the backplate further includes mounting hub defining therein a plurality of teeth apertures, and the trim ring includes a plurality of ribbed teeth configured to snap-fit into the teeth apertures and thereby removably mount the trim ring to the backplate.

9. The split block of claim 1, wherein the first plate segment defines therethrough a first hole segment and the second plate segment defines therethrough a second hole segment aligning with and adjoining the first hole segment to collectively define a fixture hole when the first and second plate segments are in the closed position.

10. The split block of claim 1, further comprising:
a locking tooth projecting axially from the first plate segment; and
a locking tab projecting from the second plate segment towards the first plate segment and defining a slot configured to receive therein the locking tooth to thereby lock the first plate segment to the second plate segment when in the closed position.

11. The split block of claim 1, wherein the backplate further includes a mounting flange projecting outward from and extending around outer peripheries of the first and second plate segments, the mounting flange configured to mount the backplate to a wall structure.

12. The split block of claim 1, wherein the backplate and the living hinge system are integrally formed as a single-piece structure from a polymeric material.

13. A method of manufacturing a split block assembly for a wall structure with a fixture, the method comprising:
forming a backplate configured to mount to the wall structure, the backplate including a first plate segment rotatable with respect to a second plate segment between an open position, whereat the first plate segment is spaced from the second plate segment, and a closed position, whereat the first and second plate segments abut and thereby cooperatively define a fixture hole configured to receive therethrough the fixture; and
forming a living hinge system integral with and rotatably joining the first and second plate segments, the living hinge system including a first living hinge adjoining the first plate segment and bending on a first axis, a second living hinge adjoining the second plate segment and bending on a second axis oblique to the first axis, and a flap extending between and joining the first and second living hinges.

14. The method of claim 13, wherein the living hinge system further includes a third living hinge interposed between the first and second living hinges and bending on a third axis oblique to the first and second axes.

15. The method of claim 14, wherein the living hinge system defines an axis of rotation about which the first and second plate segments rotate, and wherein each of the first, second, and third living hinges is substantially linear and projects radially outward from the axis of rotation.

16. The method of claim 14, wherein the flap includes a first flap interposed between and adjoining the first and third living hinges, and a second flap interposed between and adjoining the second and third living hinges.

17. The method of claim 16, wherein the living hinge system consists essentially of the first, second and third living hinges and the first and second flaps.

18. The method of claim 13, further comprising forming an annular trim ring configured to removably mount onto an axial face of the backplate when the first and second plate segments are in the closed position.

19. The method of claim 13, wherein the first plate segment defines therethrough a first hole segment and the second plate segment defines therethrough a second hole segment aligning and mating with the first hole segment to collectively define the fixture hole when the first and second plate segments are in the closed position.

20. A mounting block, comprising:
a split block backplate including at least a mounting flange, a first plate segment, and a second plate segment separated from the first plate segment by a split block line; and
a living hinge system connecting the first and second plate segments to rotate back-and-forth between open and closed positions, the living hinge system consisting essentially of multiple living hinges joined by at least one inter-hinge flap, wherein the at least one inter-hinge flap is generally coplanar to the mounting flange when in the closed position and non-planar to the mounting flange when in the open position.
